(19) United States
(12) Patent Application Publication
(10) Pub. No.: US 2008/0068735 A1
(43) Pub. Date: Mar. 20, 2008

(54) METHOD FOR ALIGNING COLOR FILTERS TO A BACK-ILLUMINATED IMAGING ARRAY

(76) Inventor: Norman Goldsmith, Princeton, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/856,276

(22) Filed: Sep. 17, 2007

Related U.S. Application Data
(60) Provisional application No. 60/846,165, filed on Sep. 20, 2006.

(51) Int. Cl. G02B 5/22

(52) U.S. Cl. 359/891

(57) ABSTRACT

A method for registering a color filter array to a back illuminated imager is disclosed, comprising the steps of providing at least one color filter array comprising filter elements of at least a first color and a second color; providing at least one back illuminated imager having a front side and a back side and comprising a plurality of pixels proximal to the front side, a first portion of the plurality of pixels being associated with the first color, and a second portion of the plurality of pixels being associated with the second color; illuminating the at least one color filter array and the back side of the back illuminated imager with monochromatic light having a wavelength corresponding to the first color; rotating and translating the at least one color filter array relative to the back illuminated imager; measuring a first response of at least one pixel associated with the second color; and repeating the rotating, translating, and measurement steps until the response is a minimum. The aligned back illuminated imager can then be adhered to the color filter array by means of an adhesive.

### CROSS-REFERENCE TO RELATED APPLICATIONS

This application claims the benefit of U.S. provisional patent application No. 60/846,165 filed Sep. 20, 2006, the disclosure of which is incorporated herein by reference in its entirety.

### FIELD OF THE INVENTION

The field of the present invention is semiconductor device fabrication and device structure. More specifically, the present invention relates to the alignment and application of color filters to back illuminated imagers.

### BACKGROUND OF THE INVENTION

CMOS or CCD image sensors are of interest in a wide variety of sensing and imaging applications in a wide range of fields including consumer, commercial, industrial, and space electronics. CCDs are employed either in front or back illuminated configurations. Front illuminated CCD imagers are more cost effective to manufacture than back illuminated CCD imagers such that front illuminated devices dominate the consumer imaging market. Front-illuminated imagers, however, have significant performance limitations such as low fill factor/low sensitivity (the active region of a pixel is typically very small (low fill factor)). As a result, there is a significant amount of interest in the development of color back illuminated imagers. Color back illuminated imagers contain an array of color filter elements sensitive to a plurality of different colors of light, such as the primary colors red, green, and blue. The filter elements can be arranged in a variety of patterns, the most commonly used being the Bayer pattern to be discussed hereinbelow in connection with the present invention.

In order to maintain color purity, each filter element needs to be precisely aligned, i.e., registered, to a corresponding pixel (at least the light sensitive portion of a pixel). In a traditional front-illuminated imager, color filter elements are applied in set of three steps using conventional photolithography and alignment tools similar to those used to create the imager itself. One common method for obtaining a registered pattern uses colored photoresists. In the photoresist process, a wafer containing a plurality of front-illuminated imagers is coated with a material (photoresist) that is sensitive to ultraviolet (UV) light. On exposure to light, the photoresist is rendered insoluble in particular solvents (developers). FIGS. 1A-1D show the process of producing color back illuminated imagers using photoresists of different colors to produce a desired filter pattern. FIG. 1A shows a portion of an array 10 of pixels 12 of a front illuminated imager before the application of photoresist. FIG. 1B shows a layer 14 of blue photoresist being applied to the entire array 10. A subset of the pixels 12 is illuminated with a pattern of UV light to which the layer 14 is sensitive. In FIG. 1C, solvents are applied to the blue photoresist such that those portions 16 exposed to UV light become insoluable and therefore remain on the wafer while other areas 17 are dissolved away. In FIG. 1D, the process is repeated for photoresists of the other colors (green and red), which results in the device shown. Note, the filter material (insoluable photoresist) need only cover the actual photo sensitive portion of a pixel. In front illuminated imagers, especially those with small pixels, a relatively large portion of the pixel is devoted to signal and control electrodes.

For back illuminated imagers, the entire area of a pixel can be used for light gathering. As a result, the entire area of the pixel can be covered with the filter material. The back side of the back-illuminated imager, therefore, can provide a single flat surface that can accept an integrated filter, i.e. a filter containing three sets of primary color filter elements aligned in pattern to match the light sensitive portions of the pixels in the imaging array. FIG. 2 show an example of a color back illuminated imager 18 having an integrated color filter array 20 positioned on a back side 22 of the imager 18 as is known in the prior art. The back illuminated imager 18 includes an array of pixels 24 each having a light sensitive region 26 located on the front side 28 of the imager 18. The back side 22 of the imager 18 is completely covered by a plurality of filter elements 30 of one or more colors arranged in a patterns such as the Bayer pattern discussed above.

If the integrated filter 20 is produced by semiconductor manufacturing processes similar to those used for front-illuminated imager color filters, the resulting color back illuminated imager 18 may have poor registration of the color filter elements 30 to the to the light sensitive regions 26 of the pixels 24. Poor registration may result because the pixels 24 on the front side 28 of the imager 18 are not directly visible to manufacturing equipment used to locate the positions of the color filter elements 30 on the back side 22.

The alignment of a color filter pattern on the back side 22 of the back illuminated imager 18 in two dimensions now becomes very important, since any shift of the pattern will result in degradation of color fidelity. Further, because such a back-illuminated color filter 20 would be constructed on the back side 24 of the imager 18 using photoresists and employing photolithography, the manufacturing of the integrated filter 20 is subject to the same solvent and etching material limitations as is found with front-illuminated imager color filters. Also, because the application of photoresists is repeated three times—one for each color—the likelihood of defects in one or more of the colors is greatly increased. Defects in a color filter pattern produces an imager 18 that does not function properly, even though the underlying imager functions properly electrically. The production of defect-free color mask patterns on the back side 22 of the imager 18 is made even more difficult when the thickness of the semiconductor material is 4 to 10 μm or less, leading to warpage and other distortions of the light sensitive regions 26 of the pixels 24.

Accordingly, what would be desirable, but has not yet been provided, is a method for aligning and affixing a monolithic integrated color filter array to the back side of a back-illuminated imager in which the manufacturing process of the color filter array is independent of the manufacturing process of the imager.

### SUMMARY OF THE INVENTION

Disclosed is an apparatus and method for registering a color filter array to a back illuminated imager, comprising the steps of providing at least one color filter array comprising filter elements of at least a first color and a second color; providing at least one back illuminated imager having a front side and a back side and comprising a plurality of pixels proximal to the front side, a first portion of the plurality of pixels being associated with the first color, and a second portion of the plurality of pixels being associated with the second color; illuminating the at least one color filter array and the back side of the back illuminated imager with monochromatic light having a wavelength corresponding to the first color; rotating and translating the at least one color filter array relative to the back illuminated imager; measuring a first response of at least one pixel associated with the second color; and repeating the rotating, translating, and measurement steps until the response is a minimum. The color filter array can also comprise elements of a third color, wherein a third response of at least one pixel associated with the third color is measured repeatedly while rotating and translating the color filter array relative to the back illuminated imager until the response for both colors that do not correspond to the illuminating source are minimized. This process can be repeated by substituting light of second color and then a third color for the illuminating source and then finding a best fit translation and rotation vector based on the three sets of measurements. The aligned back illuminated imager can then be adhered to the color filter array by means of an adhesive.

A device can be constructed from the at least one back illuminated imager and the at least one color filter array, comprising a transparent substrate; at least one color filter array comprising a plurality of filter elements of at least a first color and a second color substantially overlying said transparent substrate; an adhesive layer substantially overlying the at least one color filter array; and at least one back illuminated imager having a front side and a back side and comprising a plurality of pixels proximal to the front side, a first portion of the plurality of pixels being associated with the first color, and a second portion of the plurality of pixels being associated with the second color, wherein the at least one back illuminated imager is oriented to the at least one color filter array based on rotating and translating the at least one color filter array relative to the at least one back illuminated imager so as to minimize a response of at least one pixel associated with the second color to illuminated with monochromatic light corresponding to the first color. The at least one back illuminated imager can be a charge coupled device (CCD), a CMOS based back illuminated imager, or a plurality of back illuminated imagers arranged on a wafer. The elements of the at least one color filter array can be arranged in a Bayer pattern comprising three primary colors. The filter elements of the at least one color filter array can be made with organic dyes. Alternatively, the filter elements can include multiple thin layers of inorganic materials acting as interference filters.

### SUMMARY DESCRIPTION OF THE DRAWINGS

FIG. 1A is a schematic diagram of a portion of an array pixels of a front illuminated imager before the application of photoresist;

FIG. 1B is a schematic diagram showing a layer of blue photoresist being applied to the entire array of FIG. 1;

FIG. 1C is a schematic diagram showing solvents being applied to the blue photoresist such that those portions exposed to UV light become insoluable and therefore remain on the wafer while other areas are dissolved away;

FIG. 1D is a schematic diagram of a color front illuminated imager in the prior art after photoresists of multiple colors are applied and patterned;

FIG. 2 is a schematic diagram showing a color back illuminated imager in the prior art having an integrated color filter array positioned on a back side of the imager;

FIG. 3 is a schematic diagram depicting a monolithic color filter array constructed in accordance with an embodiment of the present invention;

FIG. 4 is a schematic block diagram showing equipment for aligning and affixing the monolithic color filter array of FIG. 3 to a back illuminated imager according to an embodiment of the present invention; and

FIG. 5 depicts a monolithic color filter array having the configuration of a Bayer pattern which can be used in conjunction with an embodiment of the present invention.

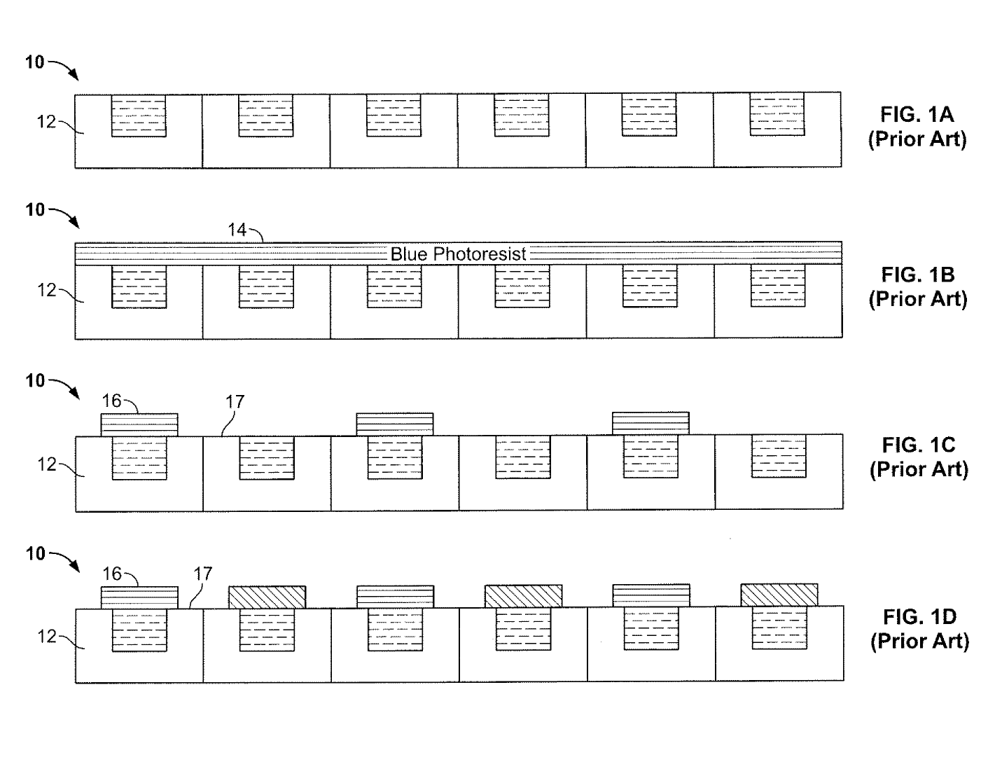

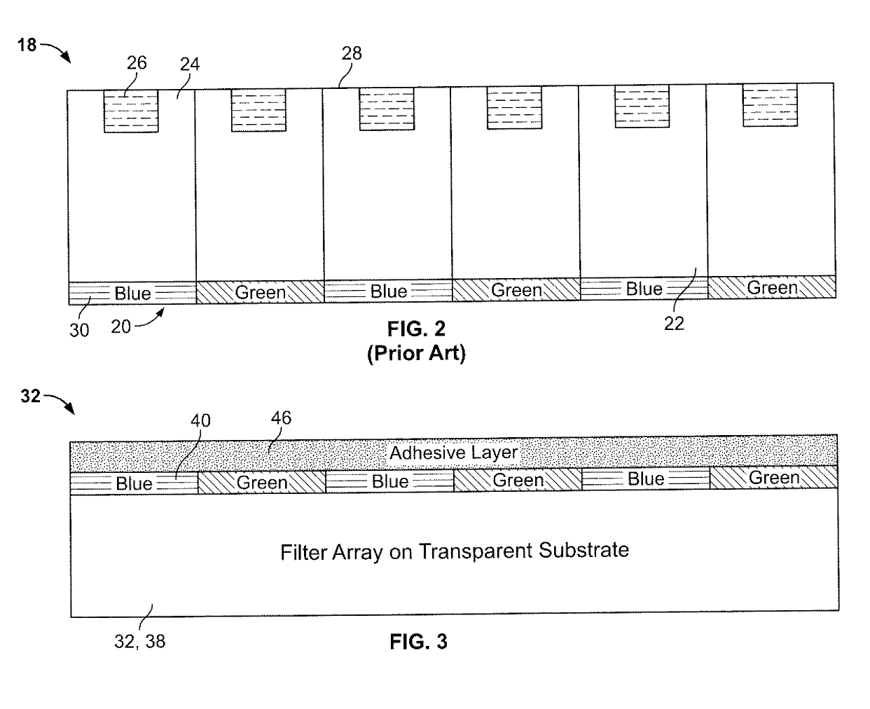

### DETAILED DESCRIPTION OF THE INVENTION

The following embodiments are intended as exemplary, and not limiting. In keeping with common practice, figures are not necessarily drawn to scale.

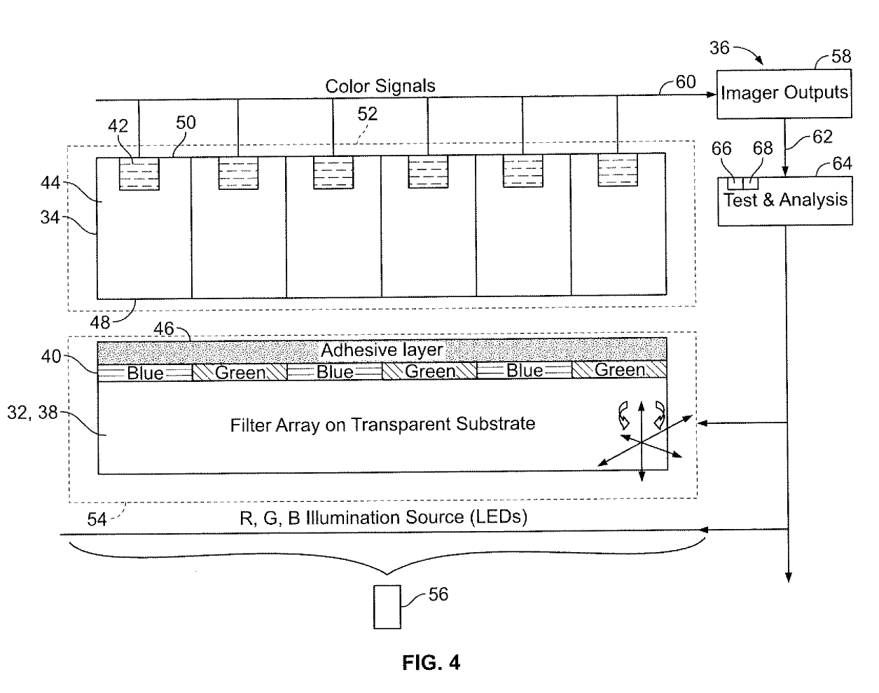

FIG. 3 depicts a monolithic color filter array 32 constructed in accordance with an embodiment of the present invention. FIG. 4 shows a back illuminated imager 34 to which the monolithic color filter array 32 is to be aligned and affixed using test equipment 36. The manufacture of the color filter array 32 is performed in a separate series of operations. The color filter array 32 includes a transparent substrate 38. The transparent substrate 38 can be made from a variety of suitable materials, such as glass or quartz. The composition of the substrate 38 should be mechanically compatible with the semi-conductor material of the back illuminated imager 34. It should also be stable over temperature and time. A plurality of color filter elements 40 of at least one color, preferably three primary colors, (e.g., red-blue-green or magneta-cyan-yellow), and incorporated into the monolithic color filter array 32 substantially overly the transparent substrate 38. Each of the plurality of color filter elements 40 is sized and shaped to substantially underlay at least the light-sensitive regions 42 of a pixel elements 44 of the back illuminated imager 34. FIG. 3 also shows an adhesive layer 46 substantially overlying the plurality of color filter elements 40. The adhesive layer 46 is provided so that the monolithic color filter array 32 may be adhered to the back surface 48 of the back illuminated imager 34. This allows for the plurality of color filter elements 32 and the back surface 48 of the back illuminated imager 34 to be in near intimate contact during the alignment process, separated only by a thin liquid layer (the adhesive layer 46). This prevents light incident on the color filter elements 40 from spreading beyond the boundaries of the light-sensitive regions 42 of pixel elements 44, which would result in optical losses and reduce sensitivity.

Because the color filter array 32 is built separately from the back-illuminated imager 34, the materials for the color filter elements 40 can be freely chosen without being subject to limitations in processing conditions which may contaminate or destroy the pixel elements 44 in the imager 34. Producing the monolithic color filter array 32 would not require any compromises to be made in chemicals used, filter materials, process temperature, application methods or other conditions that are imposed if the color filter elements 40 were to be created on an already processed imager array. Further, the entire array of color filter elements 40 can be fully inspected for defects. Separating the manufacture of the color filter array 32 from the manufacture of the imager 34 allows for greater efficiency and higher yield in both the imager 34 and the monolithic color filter array 32. Furthermore, the color filter array production process can be separately optimized for pattern fidelity. The monolithic color filter array 32 can be independently inspected for conformance to size and placement of each of the color filter elements 40. Filter arrays that do not meet quality standards can be rejected without having to reject an entire back-illuminated imager, as would be the case for an imager that has integrally manufactured color filter elements.

Referring now to FIG. 4, in a preferred embodiment, a first fixture 52 holds the back illuminated imager 34 having a back surface 48 and a front surface 50, the front surface 50 being the location for a plurality of light sensitive pixel elements 44 that can be aligned relative to the at least one color filter array 32 held by a second fixture 54. The imager 34 can be a partially packaged device that is inserted into the first fixture 52. This is a preferred embodiment since all of the electrical connections to the imager 34 are already established and tested and the package will contain an opening to allow light to fall on the imager 34. Alternatively, several imagers can be located on a surface of a wafer whose output electrodes are connected to the test equipment 36 by means of a probe card (not shown). Ideally the imagers on the wafer are located at positions close to the edge of the wafer. Likewise the at least one color filter array 32 can be a plurality of color filter arrays to be aligned with the plurality of imagers on the wafer. Individual defect-free color filter arrays can be selected.

The imager(s) 34 is/are situated such that the back surface(s) 48 can be illuminated using monochromatic light. At least one light source 56 of at least one wavelength is designed to illuminate the color filter array 32. In some embodiments, the at least one light source 56 can be an array of light sources of the three primary colors described above, corresponding to three primary colors used in the monolithic color filter array 32. The at least one light source 56 can be one or more red, green and blue light emitting diodes (LEDs) arranged as an LED array 56. The LED array 56 is constructed such that the diodes of a single color may be selected by the test equipment 36. Further, the intensity of the illumination from each color can be varied under control of the test equipment 36. The LED array 56 can be designed to provide uniform, collimated light over the area of a single imager 34. The illumination source 56 for use with large diameter wafers can comprise multiple LED arrays disposed in the approximate positions of the imagers under test.

The color filter elements 40 of independently fabricated monolithic color filter arrays 32 can be precisely registered with the light-sensitive regions 42 of a pixel elements 44 in the imager 34. Registration is performed by observing the electrical signals emanating from the imager 34. The color filter array 32 to be aligned is interposed between at least one light source 56 and the imager 34. The color filter array 32 can be translated and rotated with respect to the back surface 48 of the imager. Alternatively, the color filter array 32 can be held stationary and the imager 34 rotated and translated. The color filter array 32 or the imager 34 can be moved such that controlled contact can be established between the back surface 48 of the imager 34 and the adhesive layer 46. The test equipment 36 controls all motions of the color filter array 32 and imager 34 with respect to each other.

An imager output block 58 includes equipment for collecting the analog voltage signals 60 representing the output signals of the plurality of light sensitive pixel elements 44 and may contain equipment, such as data acquisition modules or a microcontroller containing one or more analog-to-digital converters for converting these analog voltage signals 60 to digital signals 62. A test and analysis block 64 contains at least one processor 66 and memory 68 for receiving and processing the digital signals 62. The at least one processor 66 operates on a program stored in the memory 68 for determining the light output of the plurality of pixel elements 44, and for determining a set of control signals to be applied to one or both of the fixtures 52, 54 for adjusting the relative position of the imager 34 with the color filter array 32. The second fixture 54 can be configured to be movable relative to the first fixture 54 according to three degrees of freedom of translation and three degrees of freedom of rotation.

In operation, the color filter array 32 is moved to near intimate contact with the back surface 48 of the imager 34. The imager 34 is illuminated with light of a single wavelength by the at least one light source 56 corresponding to a color associated with one type of the color filter elements 40. The analog voltages 60 produced by the plurality of pixel elements 44 is measured and converted to digital signals 62 by the imager output block 58, which in turn sends the plurality of digital signals 62 to the at least one processor 66 in the test and analysis block 64. The at least one processor 66 then signals one or both of the fixtures 52, 54 to rotate and/or translate its position so as to minimize the measured response (output voltages) from the subset of the pixel elements 44 that do not correspond to the color (wavelength) selected for illumination. Optimizing for a minimum response from the subset of pixel elements associated with the subset of color filter elements that do not correspond to the selected wavelength (color) of illumination also has the effect of maximizing the response of the subset of pixel elements associated with the color filter elements that do correspond to the selected color of illumination. Optionally, the response of the selected color of illumination can also be measured.

In some embodiments, rotation can be optimized first, wherein the at least one light source 56 comprises two LEDs of the same color widely separated for use with pixel elements disposed at extreme positions on a semiconductor wafer. It may be necessary to use at least two LEDs because it may be difficult construct a single LED light source to illuminate a semiconductor wafer that is 8-12″ in diameter. Illuminating pixels that are far apart with a single LED can exaggerate small errors in rotation. Once optimized for rotation, all of the color filter elements 40 are parallel to the pixel elements 44 and have the same center of rotation. Then, translation can be optimized using one of the two LEDs above. If response is optimized for rotation first before translation, then the adjustment for translation is simplified because all of the signal responses from the pixel elements 44 change in the same way uniformly. A person skilled in the art would appreciate that other optimization algorithms could be used, wherein translation optimization can be performed before rotation optimization, or a combination of both could be employed simultaneously.

In a preferred embodiment, the at least one light source 56 can comprise a plurality of arrays of LEDs of three primary colors so as to minimize errors caused by spread of an applied beam of light. Spreading of the light beam can also be minimized when the color filter array 32 and the imager 34 are in near intimate contact. For increased accuracy, the process outlined above can be carried out sequentially using red, then blue, and then green LEDs. By recording the relative positions of the color filter array 32 and the imager 34 using each of the three colors, a ‘best fit’ set of translation and rotation vectors can be determined. Once the optimized position and orientation of the color filter array 32 is determined, the color filter array 32 can be directly affixed to the rear surface 48 of the imager 34 using a suitable adhesive.

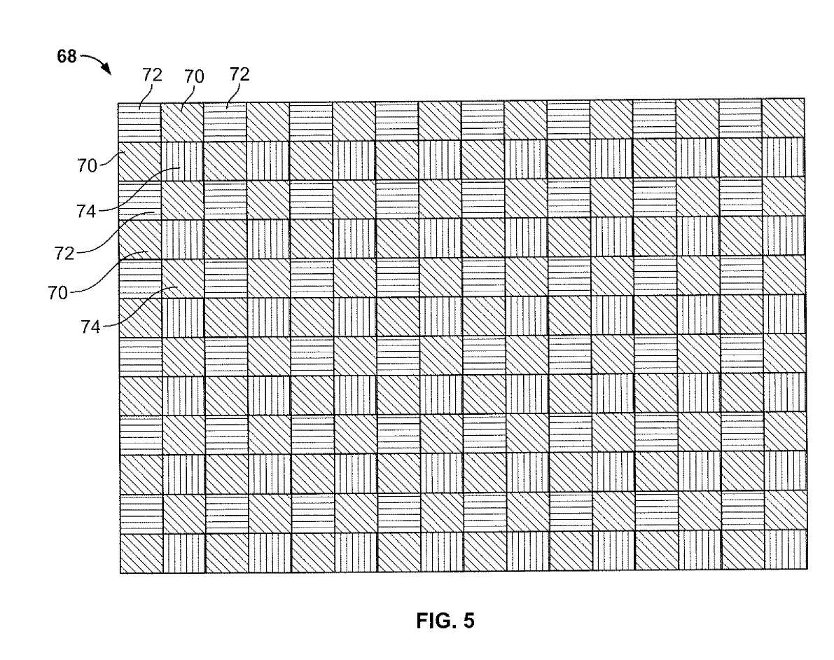

In a preferred embodiment, the alignment technique of the present invention can be used in conjunction with a monolithic filter array having the Bayer pattern previously discussed. The Bayer pattern is depicted in FIG. 5. A Bayer pattern can have RGB pixels in the ratio 1:2:1 organized as shown. In a filter array 68 constructed with colors distributed according to a Bayer pattern, there are twice as many green filter elements 70 as there are of blue 72 or red 74 filter elements. This results in greater proximity of green filter elements 70 to each other compared to the blue 72 or red 74 filter elements. Using the filter array 68 having a color distribution according to a Bayer pattern in which green is represented twice as often as red or blue is a suitable configuration of pixel color distribution because the human eye is more sensitive to green. If the Bayer pattern array 68 is illuminated with red or blue light, ideally one fourth of the pixels can have identical outputs and three-fourths will have no output. A down side to using such a pattern is that the arrangement of green filter elements 70 is symmetrical, so that that amount of movement away from one green pixel can be cancelled by the simultaneous movement by the same amount toward another green pixel, with the result that another green filter element is associated with the same pixel, thereby making it more difficult to achieve proper alignment. In such circumstances, it is best to first align on either red 74 or blue 72 filter elements, which are asymmetrical in a Bayer filter pattern, so that moving away from either a red 74 or blue 72 filter element has a lower probability of moving into an area of the Bayer array associated with another red or blue filter element. Thus, in an embodiment employing a color filter array 68 having a Bayer pattern, it would be preferable to illuminate the filter array with either red or blue light, say, for example, red light, and then adjust the relative position of the filter array 68 and/or the imager to minimize the signal to be detected in green and blue. Best results can be obtained if all of the data from the imaging array 68 is used. In a two megapixel array, for example, there are 1,000,000 green pixels and 500,000 blue and green pixels, respectively. Using blue illumination, for example, the best alignment position can be found by simultaneously minimizing the signals in the 1,500,000 other pixels. The large degree of data redundancy ensures that the best solution can be found.

The present invention is subject to modifications. For example, although the present invention is independent of the type of color filter array used, filter elements of a monolithic color filter array can be made with organic dyes. The color filter elements can include multiple thin layers of inorganic materials acting as interference filters, such as dichroic filters.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed:

1. A method for registering a color filter array to a back illuminated imager, comprising the steps of:
providing at least one color filter array comprising filter elements of at least a first color and a second color;
providing at least one back illuminated imager having a front side and a back side and comprising a plurality of pixels proximal to the front side, a first portion of the plurality of pixels being associated with the first color, and a second portion of the plurality of pixels being associated with the second color;
(a) illuminating the at least one color filter array and the back side of the back illuminated imager with monochromatic light having a wavelength corresponding to the first color;
(b) rotating and translating the at least one color filter array relative to the back illuminated imager;
(c) measuring a first response of at least one pixel associated with the second color; and
(d) repeating steps (b) and (c) until the first response is a minimum.

2. The method of claim 1, further comprising the steps of:
(e) rotating and translating the color filter array relative to the back illuminated image;
(f) measuring a second response of at least one pixel associated with the first color; and
(g) repeating steps (e) and (f) until the second response is a maximum.

3. The method of claim 1, wherein the color filter array comprises elements of a third color, and further comprising the steps of:
(h) measuring a third response of at least one pixel associated with the third color; and
(i) repeating steps (b), (c), and (h) until both the first response and the third response are minimums.

4. The method of claim 3, further comprising the steps of:
(n) substituting the second color for the first color;
(o) repeating steps (a)-(d), (h) and (i);
(p) substituting the third color for the first color;
(q) repeating steps (a)-(d), (h) and (i); and
(r) determining a best fit translation vector and rotation vector based on all of the minimum responses.

5. The method of claim 4, wherein the first color, second color, and third color are primary colors.

6. The method of claim 1, further comprising the step of adhering the color filter array to the back illuminated imager using an adhesive.

7. The method of claim 1, further comprising the step of placing the color filter array in near intimate contact with the back illuminated imager.

8. The method of claim 1, wherein step (a) is performed with at least one light emitting diode (LED).

9. The method of claim 1, wherein the elements of the at least one color filter array are arranged in a Bayer pattern.

10. The method of claim 1, wherein the at least one back illuminated imager is a charge coupled device.

11. The method of claim 1, wherein the at least one back illuminated imager is a CMOS imager.

12. The method of claim 1, wherein the at least one back illuminated imager is a plurality of back illuminated imagers arranged on a wafer.

13. The method of claim 1, wherein the filter elements of the at least one color filter array are made with organic dyes.

14. The method of claim 1, wherein the filter elements include multiple thin layers of inorganic materials acting as interference filters.

15. A device, comprising:
a transparent substrate;
at least one color filter array comprising a plurality of filter elements of at least a first color and a second color substantially overlying said transparent substrate;
an adhesive layer substantially overlying the at least one color filter array; and
at least one back illuminated imager having a front side and a back side and comprising a plurality of pixels proximal to the front side, a first portion of the plurality of pixels being associated with the first color, and a second portion of the plurality of pixels being associated with the second color,
wherein the at least one back illuminated imager is oriented to the at least one color filter array based on rotating and translating the at least one color filter array relative to the at least one back illuminated imager so as to minimize a response of at least one pixel associated with the second color to illuminated with monochromatic light corresponding to the first color.

16. The device of claim 15, wherein the at least one back illuminated imager is a charge coupled device (CCD).

17. The device of claim 15, wherein the at least one back illuminated imager is a CMOS imager.

18. The device of claim 15, wherein the at least one back illuminated imager is a plurality of back illuminated imagers arranged on a wafer.

19. The device of claim 15, wherein the elements of the at least one color filter array are arranged in a Bayer pattern.

20. The device of claim 15, wherein the filter elements of the at least one color filter array are made with organic dyes.

21. The device of claim 15, wherein the filter elements include multiple thin layers of inorganic materials acting as interference filters.

22. A method for registering a color filter array to a back illuminated imager, comprising the steps of:
providing at least one color filter array comprising filter elements of at least a first color and a second color;
providing at least one back illuminated imager having a front side and a back side and comprising a plurality of pixels proximal to the front side, a first portion of the plurality of pixels being associated with the first color, and a second portion of the plurality of pixels being associated with the second color;
(a) illuminating the at least one color filter array and the back side of the back illuminated imager with monochromatic light having a wavelength corresponding to the first color;
(b) rotating the at least one color filter array relative to the back illuminated imager;
(c) measuring a first response of at least one pixel associated with the second color; and
(d) repeating steps (b) and (c) until the first response is a minimum;
(e) translating the color filter array relative to the back illuminated imager;
(f) measuring a second response of at least one pixel associated with the second color; and
(g) repeating steps (e) and (f) until the second response is a minimum.

23. A method for registering a color filter array to a back illuminated imager, comprising the steps of:
providing at least one color filter array comprising filter elements of at least a first color, a second color, and a third color;
providing at least one back illuminated imager having a front side and a back side and comprising a plurality of pixels proximal to the front side, a first portion of the plurality of pixels being associated with the first color, a second portion of the plurality of pixels being associated with the second color, and third portion of the plurality of pixels being associated with the third color;
(a) illuminating the at least one color filter array and the back side of the back illuminated imager with monochromatic light having a wavelength corresponding to the first color;
(b) rotating the at least one color filter array relative to the back illuminated imager;
(c) measuring a first response of at least one pixel associated with the second color;
(d) measuring a second response of at least one pixel associated with the third color;
(e) repeating steps (b), (c), and (d) until the first response and the second response are minimums;
(f) translating the color filter array relative to the back illuminated imager;
(g) measuring a third response of at least one pixel associated with the second color;
(h) measuring a fourth response of at least one pixel associated with the third color; and
(i) repeating steps (f), (g), and (h) until the third response and the fourth response are minimums.
